(19) United States
(12) Patent Application Publication
(10) Pub. No.: US 2024/0355564 A1
(43) Pub. Date: Oct. 24, 2024

(54) ELECTROMAGNETIC RELAY

(71) Applicant: OMRON Corporation, Kyoto-shi (JP)

(72) Inventors: Takeshi NISHIDA, Kyoto-shi (JP); Ayaka MIYAKE, Kyoto-shi (JP); Hiroyasu TANAKA, Kyoto-shi (JP)

(21) Appl. No.: 18/627,452

(22) Filed: Apr. 5, 2024

(30) Foreign Application Priority Data
Apr. 21, 2023 (JP) 2023-069856

(51) Int. Cl. H01H 50/02; H01H 50/44

(52) U.S. Cl. CPC H01H 50/026; H01H 2050/446

(57) ABSTRACT

An electromagnetic relay includes a contact device, a driving device, an insulating member, and a cover. The contact device includes a first fixed terminal, a second fixed terminal, and a movable contact piece. The driving device generates an electromagnetic force to move the movable contact piece. The insulating member is fixedly attached to the driving device and separates the contact device from the driving device. The cover is fixed to the insulating member and defines an accommodation space together with the insulating member to accommodate the contact device. One of the insulating member and the cover includes a plurality of convex portions projecting toward the other of the insulating member and the cover. The other of the insulating member and the cover includes a plurality of concave portions to be fixed to the plurality of convex portions.

### CROSS-REFERENCE TO RELATED APPLICATION

This application claims priority to Japanese Patent Application No. 2023-069856, filed Apr. 21, 2023. The contents of that application are incorporated by reference herein in their entirety.

### FIELD

The claimed invention relates to an electromagnetic relay.

### BACKGROUND

The electromagnetic relay described in Japanese Patent Application Publication No. 1994-012956 includes a base, an insulating member placed over the base, a contact device placed between the base and the insulating member, and a driving device for operating the contact device. The driving device is fixedly attached to the insulating member.

In conventional electromagnetic relays, the insulating member is placed over the base and is not firmly fixed to the base. Thus, it is difficult to stably assemble the driving device to the contact device.

### SUMMARY

An object of the claimed invention is to provide an electromagnetic relay in which a driving device can be stably assembled to a contact device.

An electromagnetic relay according to one aspect of the claimed invention includes a contact device, a driving device, an insulating member, and a cover. The contact device includes a first fixed terminal including a first fixed contact, a second fixed terminal including a second fixed contact, and a movable contact piece opposing the first fixed contact and the second fixed contact. The driving device is disposed on one side of in a first direction with respect to the contact device and configured to generate an electromagnetic force to move the movable contact piece. The insulating member is fixedly attached to the driving device and separates the contact device from the driving device. The cover is fixed to the insulating member and defines an accommodation space together with the insulating member to accommodate the contact device. One of the insulating member and the cover includes a plurality of convex portions projecting toward the other of the insulating member and the cover. The other of the insulating member and the cover includes a plurality of concave portions to be fixed to the plurality of convex portions.

In this electromagnetic relay, the insulating member fixedly attached to the driving device is fixed to the cover by the plurality of convex portions and the plurality of concave portions. This configuration allows the driving device to be stably assembled to the contact device, thereby stabilizing the operating characteristics of the electromagnetic relay. In addition, the insulating member and the cover can be firmly fixed, and thereby the shock resistance and vibration characteristics of the electromagnetic relay are improved.

The plurality of convex portions may protrude along the first direction. In this case, the assembly between the insulating member and the cover can be facilitated.

The plurality of convex portions may be fixed by press-fitting to the plurality of concave portions. In this case, the insulating member and the cover can be firmly fixed to each other.

The insulating member may include a plurality of convex portions. The cover may include a plurality of concave portions. The plurality of concave portions may penetrate through the cover in the first direction. The plurality of convex portions and the plurality of concave portions may be fixed to each other via adhesive. In this case, the adhesive can be filled into the concave portions after the insulating member is assembled to the cover. The adhesive allows the insulating member and the cover to be firmly fixed with each other.

The plurality of convex portions and the plurality of concave portions each may have a frustum shape. In this case, the adhesive is unlikely to flow into the inside of the cover.

One of the insulating member and the cover may include a pressing protrusion that projects in a direction of movement of the movable contact piece. The other of the insulating member and the cover may be pressed against the one of the insulating member and the cover by the pressing protrusion, in the direction of movement of the movable contact piece, to be positioned. In this case, the insulating member can be positioned in the direction of movement of the movable contact piece with respect to the cover member with a simple configuration.

The first fixed terminal and the second fixed terminal may be fixed by press-fitting to the cover. In this case, the first fixed terminal, the second fixed terminal, and the insulating member can be assembled to the cover from the same direction, thereby facilitating the assemble of the electromagnetic relay.

One of the insulating member and the cover may include an insulating wall extending in a direction intersecting the direction of movement of the movable contact piece. Either the plurality of convex portions or the plurality of concave portions may be disposed on the insulating wall. In this case, the plurality of convex portions can be realized with a simple configuration.

One of the insulating member and the cover may include a first terminal fixing section to which the first fixed terminal is fixed. The first terminal fixing section may be connected to the insulating wall. In this case, since the insulating wall where either the plurality of convex portions or the plurality of concave portions is arranged is connected to the first terminal fixing section to which the first fixed terminal is fixed, and thereby the assembly of the driving device to the contact device can be more stable.

### BRIEF DESCRIPTION OF THE DRAWINGS

FIG. 1 is a perspective view of an electromagnetic relay in accordance with the claimed invention.

FIG. 2 is a bottom view of the electromagnetic relay.

FIG. 3 is cross-sectional view of the electromagnetic relay.

FIG. 4 is a perspective view of the electromagnetic relay in FIG. 1 with a driving device and an insulating member removed.

FIG. 5 is a perspective view of the electromagnetic relay in FIG. 1 with a driving device removed.

FIG. 6 is a diagram of an insulating member viewed diagonally from below.

FIG. 7 is a perspective view of a second cover.

FIG. 8 is a partial cross-sectional view of an electromagnetic relay.

FIG. 9 is a perspective view of a second cover according to a modification.

FIG. 10 is a cross-sectional perspective view of a second cover and an insulating member according to a modification.

FIG. 11 is a partial cross-sectional view of an electromagnetic relay according to a modification.

### DETAILED DESCRIPTION

An embodiment of an electromagnetic relay 1 according to one aspect of the claimed invention will be described below with reference to the drawings. When referring to the drawings, the direction indicated by arrows X1 and X2 (an example of the first direction) will be explained as a front-rear direction. The direction indicated by arrows Y1, Y2 will be explained as a left-right direction, and the direction indicated by arrows Z1, Z2 will be explained as an up-down direction. Also, in the description below, the direction indicated by the arrow X1 is forward, the direction indicated by arrow X2 is rearward, the direction indicated by arrow Y1 is leftward, the direction indicated by arrow Y2 is rightward, the direction indicated by arrow Z1 is upward, and the direction indicated by arrow Z2 is downward. These directions are defined for convenience of description, and do not limit the arrangement directions of electromagnetic relay 1.

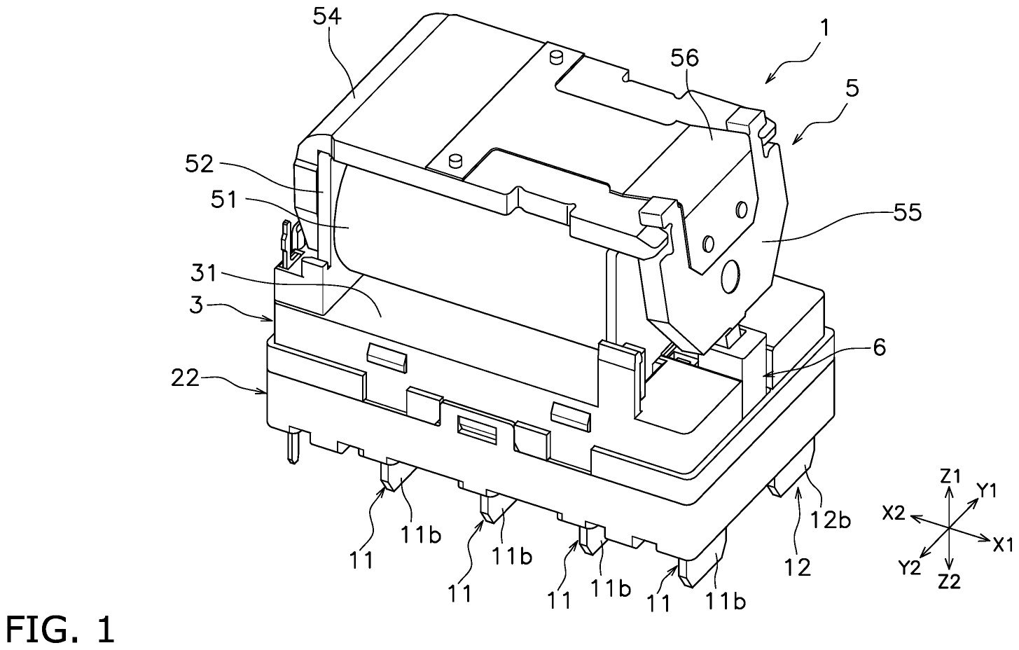

As shown in FIGS. 1 to 4, the electromagnetic relay 1 includes a case 2, an insulating member 3, a contact device 4, a driving device 5, a movable member 6, and a return spring 7.

The case 2 is comprised of insulating material such as resin. The case 2 includes a first cover 21 and a second cover 22 (an example of the cover). The first cover 21 has a substantially rectangular box shape and is open downward. The first cover 21 is arranged above the insulating member 3. The first cover 21 is retained upward relative to the insulating member 3 by, for example, a snap fit. Note that the first cover 21 is not shown in FIG. 1.

The second cover 22 has a substantially rectangular box shape and is open upward. The second cover 22 is arranged below the insulating member 3. The second cover 22 is fixed to the insulating member 3 and defines an accommodating space together with the insulating member 3 to accommodate the contact device 4. The second cover 22 is retained downward relative to the insulating member 3 by, for example, a snap fit.

The second cover 22 includes a bottom portion 22a, multiple terminal insertion holes 22b, and an adhesive-receiving portion 22c. The bottom portion 22a extends in a direction intersecting the up-down direction and faces the insulating member 3 in the up-down direction. The multiple terminal insertion holes 22b are through-holes extending through the bottom portion 22a in the up-down direction. The adhesive-receiving portion 22c has a groove shape. The adhesive-receiving portion 22c is recessed at the lower surface of the bottom portion 22a toward upward. The adhesive-receiving portion 22c is arranged around the terminal insertion holes 22b. The adhesive-receiving portion 22c is connected to the terminal insertion holes 22b. Part of the adhesive-receiving portion 22c is arranged at the inner peripheral portion of the terminal insertion holes 22b. The adhesive-receiving portion 22c is filled with adhesive 24.

The insulating member 3 is comprised of insulating material such as resin. The insulating member 3 separates the contact device 4 from the driving device 5. The insulating member 3 is disposed between the contact device 4 and the driving device 5. The insulating member 3 insulates the contact device 4 from the driving device 5. The insulating member 3 defines, in the case 2, a space where the contact device 4 is disposed and a space where the driving device 5 is disposed. The insulating member 3 is fixedly attached to the driving device 5. The insulating member 3 will be described in more detail below.

The contact device 4 is disposed in the accommodating space defined by the second cover 22 and the insulating member 3. The contact device 4 includes multiple contact sets 10. In the present embodiment, the contact device 4 includes four contact sets 10: first to fourth contact sets 10a to 10d. The first to fourth contact sets 10a to 10d are arranged side by side with each other in the front-rear direction.

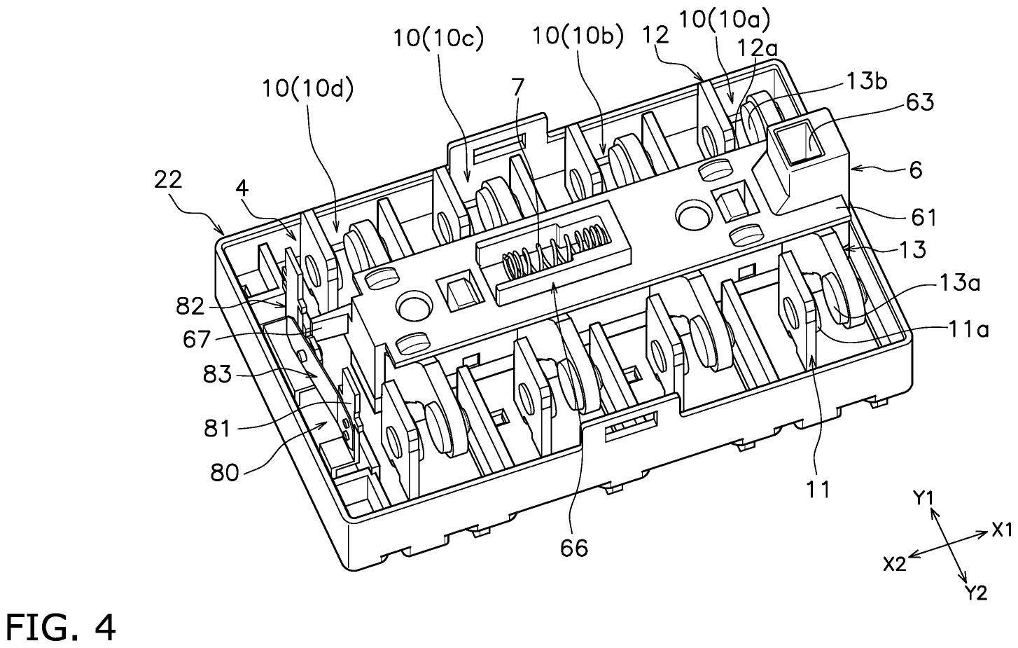

The first to fourth contact sets 10a to 10d have similar configurations. Each of the first to fourth contact sets 10a to 10d includes a first fixed terminal 11, a second fixed terminal 12, a movable contact piece 13, and a contact spring 14. Here, only the details of the first fixed terminal 11, the second fixed terminal 12, the movable contact piece 13, and the contact spring 14 of the first contact set 10a will be explained. In FIG. 4, the same reference numerals as those in the first contact set 10a in the second to fourth contact sets 10b to 10d are omitted.

The first fixed terminal 11 is a plate terminal and is comprised of conductive material. The first fixed terminal 11 is supported by the insulating member 3. The first fixed terminal 11 is fixed to the insulating member 3, for example, by press-fitting.

The first fixed terminal 11 includes a first fixed contact 11a and a first external connection 11b. The first fixed contact 11a is arranged on the front surface of the first fixed terminal 11. The first external connection 11b projects downward from the terminal insertion hole 22b of the second cover 22.

The second fixed terminal 12 is a plate terminal and is comprised of conductive material. The second fixed terminal 12 is supported by the insulating member 3. The second fixed terminal 12 is fixed to the insulating member 3, for example, by press-fitting. The second fixed terminal 12 is arranged apart from the first fixed terminal 11 in the left-right direction.

The second fixed terminal 12 includes a second fixed contact 12a and a second external connection 12b. The second fixed contact 12a is arranged on the front surface of the second fixed terminal 12. The second external connection 12b projects downward from the terminal insertion hole 22b the second cover 22.

The movable contact piece 13 is a plate terminal and is comprised of conductive material. The movable contact piece 13 extends in the left-right direction. The movable contact piece 13 is arranged in front of the first fixed contact 11a and the second fixed contact 12a, and is opposed to the first fixed contact 11a and the second fixed contact 12a in the front-rear direction. The movable contact piece 13 is connected to the movable member 6 via the contact spring 14 in the front-rear direction. The movable contact piece 13 is arranged to be movable relative to the movable member 6 in the front-rear direction. The movable contact piece 13 is configured to be movable in the front-rear direction. The movable contact piece 13 is configured to be movable in a contact direction from the first movable contact 13a toward the first fixed contact 11a and in a separation direction opposite to the contact direction. In the present embodiment, the contact direction corresponds to the rearward direction, and the separation direction corresponds to the forward direction.

The movable contact piece 13 includes a first movable contact 13a, a second movable contact 13b, and a positioning section 13c. The first movable contact 13a faces the first fixed contact 11a in the front-rear direction. The first movable contact 13a contacts or separates from the first fixed contact 11a in accordance with the movement of the movable member 6. The second movable contact 13b faces the second fixed contact 12a in the front-rear direction. The second movable contact 13b contacts the second fixed contact 12a or separates from the second fixed contact 12a in accordance with the movement of the movable member 6. The positioning section 13c is located at the center of the movable contact piece 13 in the left-right direction. The positioning section 13c has a protrusion shape projecting forward from the front surface of the movable contact piece 13.

The contact spring 14 urges the movable contact piece 13 in the direction of contact. The contact spring 14 is positioned by the positioning section 13c.

The driving device 5 is arranged in the internal space defined by the insulating member 3 and the first cover 21. The driving device 5 is arranged above the contact device 4 and the movable member 6. The driving device 5 is fixedly attached to the top of the insulating member 3. The driving device 5 is configured to move the movable contact piece 13 of each of the first to fourth contact sets 10a to 10d in the front-rear direction via the movable member 6. In the present embodiment, the driving device 5 generates electromagnetic force for moving the movable member 6 in the direction of contact.

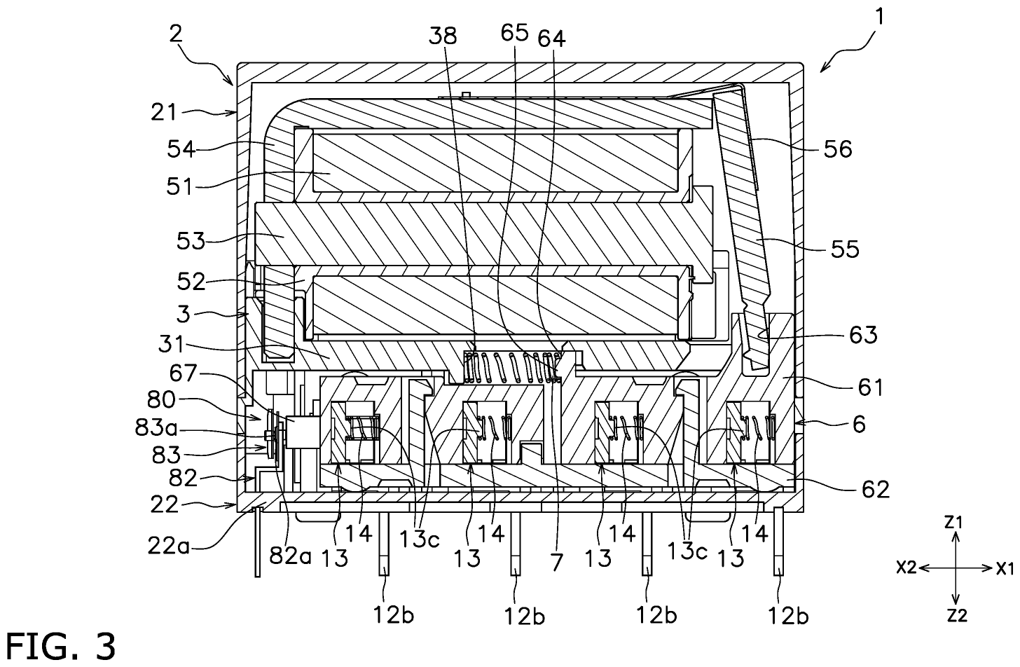

As shown in FIGS. 1 and 3, the driving device 5 includes a coil 51, a bobbin 52, a fixed iron core 53, a yoke 54, a movable iron piece 55, and a hinge spring 56. The coil 51 is wound around the bobbin 52. The axis of the bobbin 52 extends in the front-rear direction. The fixed iron core 53 is disposed within the bobbin 52. Both ends of the fixed iron core 53 in the front-rear direction protrude from the bobbin 52. The yoke 54 has a bent shape, e.g, an L-shape. The yoke 54 is arranged above the coil 51 and behind the bobbin 52. The yoke 54 is connected to the rear end of the fixed iron core 53.

The movable iron piece 55 is connected to the front end of the yoke 54. The movable iron piece 55 is rotatably supported by the yoke 54 via the hinge spring 56. The movable iron piece 55 rotates about the front end of the yoke 54 as a fulcrum. The movable iron piece 55 is arranged in front of the fixed iron core 53. The lower end of the movable iron piece 55 is connected to the movable member 6. The hinge spring 56 urges the movable iron piece 55 in a direction away from the fixed iron core 53.

The movable member 6 is comprised of insulating material such as resin. The movable member 6 extends in the front-rear direction. The movable member 6 is disposed below the insulating member 3. The movable member 6 is placed on top of the second cover 22. The movable member 6 is arranged between the first fixed terminal 11 and the second fixed terminal 12. The movable member 6 is configured to press the movable contact piece 13. The movable member 6 is pressed by the movable iron piece 55 as the movable iron piece 55 rotates. With this configuration, the movable member 6 is movable in the front-rear direction.

As shown in FIGS. 3 and 4, the movable member 6 includes a main body section 61, a cover section 62, an insertion hole 63, a first contact section 64, a positioning section 65, and an insulating wall 66. The main body section 61 includes four spaces in which the movable contact pieces 13 and contact springs 14 of each of the first to fourth contact sets 10a to 10d are accommodated, respectively. The four spaces are aligned side-by-side in the front and rear direction. As shown in FIG. 3, the cover section 62 closes off the lower portions of the four spaces. The cover section 62 is coupled to the main body section 61 by a snap fit, for example. The insertion hole 63 is located at the upper portion of the front end of the main body section 61. The insertion hole 63 extends in the up-down direction. The insertion hole 63 is open upward, into which the lower end of the movable iron piece 55 is inserted. The insertion hole 63 is arranged within an opening formed in the insulating member 3.

The first contact section 64 extends in a direction intersecting the front-rear direction. The first contact section 64 is where the front end of the return spring 7 contacts.

The positioning section 65 positions the first end of the return spring 7. The positioning section 65 is shaped to protrude rearward from the rear surface of the first contact section 64.

The insulating wall 66 projects upward from the upper surface of the main body section 61. The insulating wall 66 extends in a direction intersecting the left-right direction. The insulating wall 66 is arranged to surround the left and right sides of the return spring 7. The insulating wall 66 insulates between the return spring 7 and the contact device 4.

Here, as shown in FIGS. 3 to 5, the insulating member 3 includes a partition wall 31, multiple positioning concave portions 32, a first terminal fixing section 33, a second terminal fixing section 34, a first insulating wall 35, a second insulating wall 36, an opening 37, a second contact section 38, and a guide section 39.

The partition wall 31 separates the contact device 4 from the driving device 5. The partition wall 31 defines, within the case 2, a space where the contact device 4 is disposed and a space where the driving device 5 is disposed. The partition wall 31 extends in a direction intersecting the up-down direction.

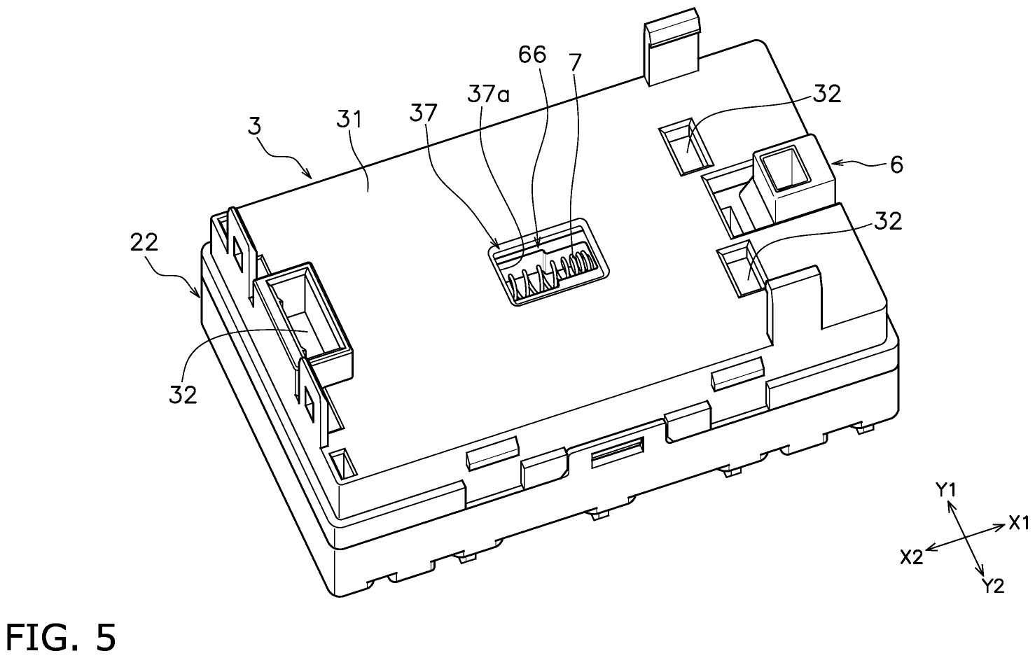

As shown in FIG. 5, the positioning concave portions 32 are arranged on the upper surface of the partition wall 31. The positioning concave portions 32 are recessed downward. The positioning concave portions 32 position the bobbin 52 and the yoke 54. The bobbin 52 and the yoke 54 are fixed, for example by press-fitting, to the partition wall 31. With this configuration, the driving device 5 is fixedly attached to the insulating member 3.

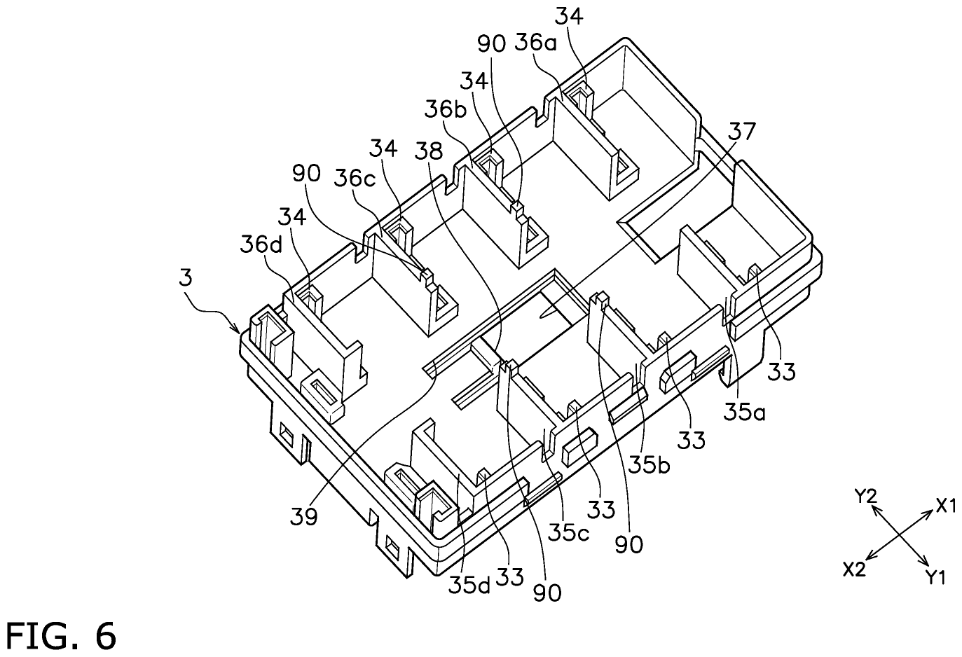

As shown in FIG. 6, the first terminal fixing section 33 and the second terminal fixing section 34 extend downward from the lower surface of the partition wall 31. The first terminal fixing section 33 and the second terminal fixing section 34 are recessed upward. The first terminal fixing section 33 is separated from the second terminal fixing section 34 in the left-right direction. The first fixed terminal 11 is fixed by press-fitting to the first terminal fixing section 33. The second fixed terminal 12 is fixed by press-fitting to the second terminal fixing section 34. The first terminal fixing section 33 and the second terminal fixing section 34 are provided according to the number of the multiple contact sets 10.

The first insulating walls 35a-35d and the second insulating walls 36a-36d extend downward from the lower surface of the partition wall 31. The first insulating walls 35a-35d and the second insulating walls 36a-36d extend in a direction intersecting the front-rear direction. The first insulating walls 35a-35d are connected to the first terminal fixing section 33. The first insulating walls 35a-35d extend downward from the first terminal fixing section 33. The first insulating walls 35a-35d are separated from the second insulating walls 36a-36d in the left-right direction. The second insulating walls 36a-36d are connected to the second terminal fixing section 34. The second insulating walls 36a-36d extend downward from the second terminal fixing section 34. The movable member 6 is arranged between the first insulating walls 35a-35d and the second insulating walls 36a-36d.

The first insulating walls 35a to 35c and the second insulating walls 36a to 36c insulate between the multiple contact sets 10. The first insulating wall 35a and the second insulating wall 36a are arranged between the first contact set 10a and the second contact set 10b. The first insulating wall 35a and the second insulating wall 36a insulate between the first contact set 10a and the second contact set 10b. The first insulating wall 35b and the second insulating wall 36b are arranged between the second contact set 10b and the third contact set 10c. The first insulating wall 35b and the second insulating wall 36b insulate between the second contact set 10b and the third contact set 10c. The third insulating wall 35c and the third insulating wall 36c are arranged between the third contact set 10c and the fourth contact set 10d. The third insulating wall 35c and the third insulating wall 36c insulate between the third contact set 10c and the fourth contact set 10d. The first insulating wall 35d and the second insulating wall 36d are arranged between the fourth contact set 10d and an auxiliary contact device 80 which will be described later. The first insulating wall 35d and the second insulating wall 36d insulate between the fourth contact set 10d and the auxiliary contact device 80.

The opening 37 is open upward. The opening 37 is where the return spring 7 is inserted. The opening 37 passes through the partition wall 31 in the up-down direction.

The second contact section 38 projects downward from the lower surface of the partition wall 31. The second contact section 38 extends in a direction intersecting the front-rear direction. The second contact section 38 is where the rear end of the return spring 7 contacts.

The guide section 39 guides the movement of the movable member 6 in the front-rear direction. The guide section 39 guides the movement of the insulating wall 66 of the movable member 6 in the front-rear direction. The guide section 39 is formed on the lower surface of the partition wall 31. The guide section 39 extends in the front-rear direction. The guide section 39 has a groove shape. The insulating wall 66 is arranged within the groove of the guide section 39 and is slidable with respect to the guide section 39.

The return spring 7 urges the movable member 6 in the separation direction. The return spring 7 is, for example, a coil spring, and is arranged between the driving device 5 and the movable member 6 in the up-down direction. The return spring 7 is arranged between the first contact section 64 and the second contact section 38.

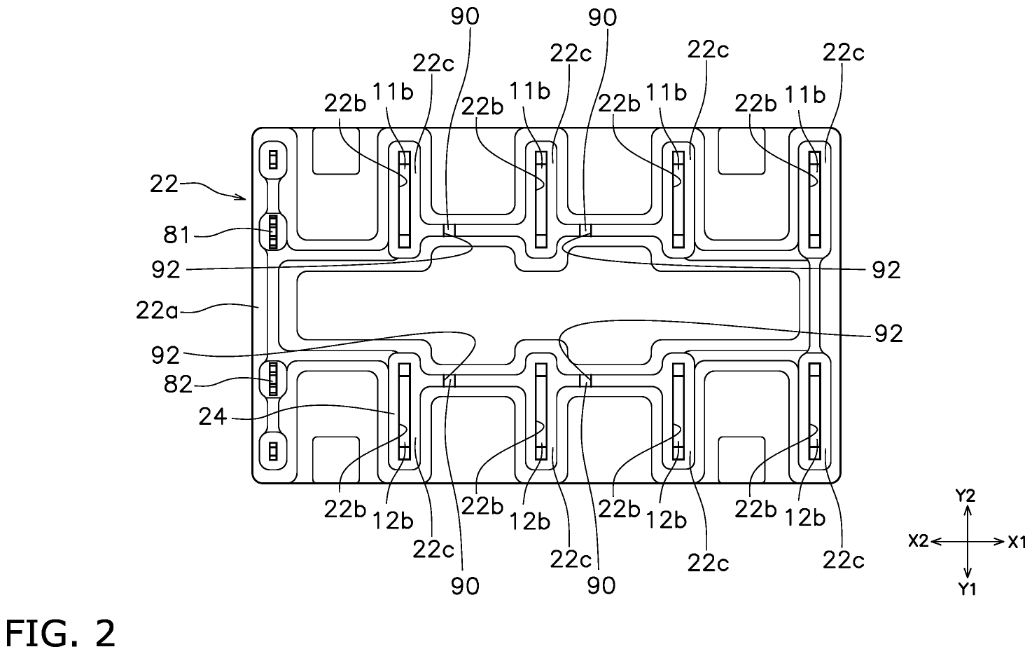

As shown in FIGS. 2 and 3, the electromagnetic relay 1 further includes an auxiliary contact device 80. The auxiliary contact device 80 is aligned with the contact device 4 in the front-rear direction. The auxiliary contact device 80 is arranged behind the contact device 4. The auxiliary contact device 80 includes a first auxiliary fixed terminal 81, a second auxiliary fixed terminal 82, and an auxiliary movable contact piece 83.

The first auxiliary fixed terminal 81 and the second auxiliary fixed terminal 82 are supported by the insulating member 3. The first auxiliary fixed terminal 81 is separated from the second auxiliary fixed terminal 82 in the left-right direction. The second auxiliary fixed terminal 82 includes an auxiliary fixed contact 82a. The auxiliary fixed contact 82a is arranged on the front surface of the first auxiliary fixed terminal 81.

The auxiliary movable contact piece 83 is composed of a leaf spring. The auxiliary movable contact piece 83 extends in the left-right direction. The auxiliary movable contact piece 83 has one end fixed to the first auxiliary fixed terminal 81. The other end of the auxiliary movable contact piece 83 is a free end and is arranged behind the auxiliary fixed contact 82a. The other end of the auxiliary movable contact piece 83 faces the auxiliary fixed contact 82a in the front-rear direction.

The auxiliary movable contact piece 83 includes an auxiliary movable contact 83a. The auxiliary movable contact 83a is arranged at the free end of the auxiliary movable contact piece 83. The free end of the auxiliary movable contact piece 83 is pressed against a pressing protrusion 67 of the movable member 6 as the movable member 6 moves. With this configuration, the auxiliary movable contact 83a is able to contact or separate from the auxiliary fixed contact 82a.

In the present embodiment, the auxiliary movable contact 83a contacts the auxiliary fixed contact 82a in a state where the free end of the auxiliary movable contact piece 83 is not pressed against the pressing protrusion 67. In contrast, the auxiliary movable contact 83a separates from the auxiliary fixed contact 82a in a state where the free end of the auxiliary movable contact piece 83 is pressed against the pressing protrusion 67.

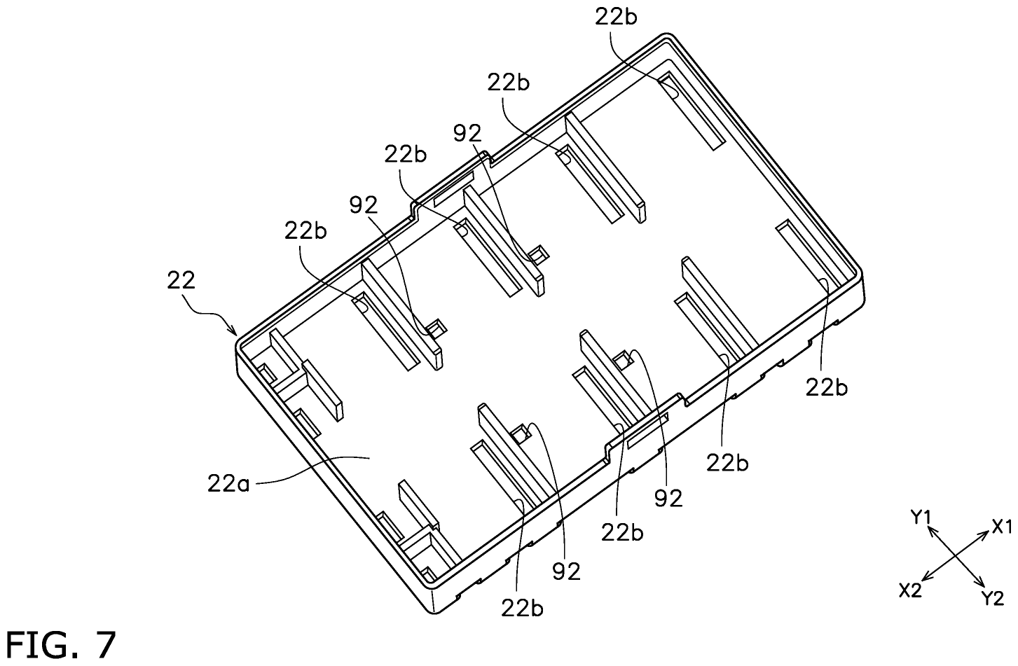

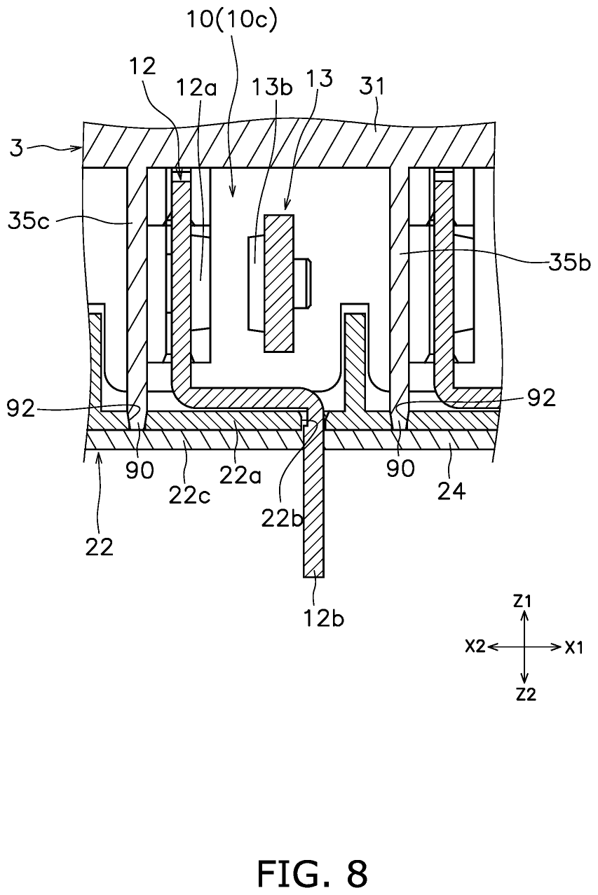

As shown in FIGS. 6 to 8, one of the insulating member 3 and second covers 22 includes multiple convex portions 90 projecting toward the other of the insulating member 3 and second covers 22. The other of insulating member 3 and second cover 22 includes multiple concave portions 92 to be fixed to the multiple convex portions 90. In the present embodiment, the insulating member 3 includes the convex portions 90, and the second cover 22 includes the concave portions 92.

The convex portions 90 extend in the up-down direction. The convex portions 90 have a truncated conical shape with an outer diameter decreasing downward. The convex portions 90 are arranged on each of the first insulating walls 35b, 35c and the second insulating walls 36b, 36c. The convex portions 90 protrude from each of the lower portions of the first insulating walls 35b, 35c and the second insulating walls 36b, 36c in the up-down direction toward the bottom portion 22a of the second cover 22. The convex portions 90 are received in the concave portions92. In the present embodiment, the convex portions 90 are fixed by press-fitting to the concave portions 92. The convex portions 90 are inserted into the concave portions 92 from above the concave portions 92, respectively. With this configuration, the second cover 22 is fixed to the insulating member 3. The tips of the convex portions 90 may protrude beyond the concave portions 92. The tips of the convex portions 90 may be placed within the adhesive-receiving portion 22c.

The concave portions 92 are provided corresponding to the convex portions 90, respectively. The concave portions 92 are through-holes penetrating the bottom portion 22a of the second cover 22 in the up-down direction. In the present embodiment, the concave portions 92 penetrate the adhesive-receiving portion 22c in the up-down direction. The concave portions 92 have a truncated conical shape with an outer diameter decreasing downward.

Next, the operations of contact device 4, driving device 5, and movable member 6 will be explained. When no voltage is applied to the coil 51, the movable member 6 is pressed in the separation direction by the elastic force of the hinge spring 56 and the return spring 7, and the movable member 6 is located at the return position shown in FIG. 3. At this time, in each of the first contact set 10a to the fourth contact set 10d, the first movable contact 13a is separated from the first fixed contact 11a, and the second movable contact 13b is separated from the second fixed contact 12a.

When a voltage is applied to the coil 51 and the driving device 5 is excited, the movable iron piece 55 is attracted to the fixed iron core 53 and rotates, and the movable member 6 is pressed in the contact direction. As a result, the movable member 6 moves in the contact direction against the elastic force of the return spring 7. As the movable member 6 moves in the contact direction, the movable contact piece 13 in each of the first to fourth contact sets 10a to 10d moves in the contact direction. Accordingly, in each of the first to fourth contact sets 10a to 10d, the first movable contact 13a is brought into contact with the first fixed contact 11a, and the second movable contact 13b is brought into contact with the second fixed contact 12a. When the voltage application to the coil 51 is stopped, the movable member 6 moves in the separation direction by the elastic force of the hinge spring 56 and the return spring 7 and returns to the return position.

In this electromagnetic relay 1, the insulating member 3 fixed to the driving device 5 is fixed to the second cover 22 by the multiple convex portions 90 and the multiple concave portions 92. This configuration allows the driving device 5 to be stably assembled to the contact device 4, thereby stabilizing the operating characteristics of the electromagnetic relay 1. Furthermore, since the insulating member 3 and the second cover 22 can be firmly fixed, the shock resistance and vibration characteristics of the electromagnetic relay 1 are improved.

The multiple convex portions 90 are arranged on the first insulating walls 35b, 35c connected to the first terminal fixing section 33 and on the second insulating walls 36b, 36c connected to the second terminal fixing section 34, respectively. Thus, the driving device 5 can be further stably assembled to contact device 4.

One embodiment of the electromagnetic relay according to one aspect of the claimed invention has been described above. The claimed invention, however, is not limited to the above embodiment, and various changes can be made without departing from the scope of the claimed invention.

The configuration of contact device 4 may be changed. The contact device 4 only needs to include at least one contact set. For example, the second to fourth contact sets 10b to 10d may be omitted. The auxiliary contact device 80 may be omitted. The contact device 4 may include a contact set of B-contact type. The first fixed terminal 11 and the second fixed terminal 12 may be fixed by press-fitting to the second cover 22. The claimed invention may be applied to an electromagnetic relay in which the movable contact piece 13 is arranged behind the first fixed terminal 11 and the second fixed terminal 12.

The configuration of convex portions 90 and concave portions 92 may be changed. The convex portions 90 and the concave portions 92 may have a cylindrical shape or a prismatic shape. The convex portions 90 and the concave portions 92 may be fixed to each other by snap-fit connections. The arrangement of convex portions 90 and concave portions 92 may be changed. The convex portions 90 may be arranged in locations, in the insulating member 3, other than the first insulating walls 35a to 35d and the second insulating walls 36a to 36d.

The concave portions 92 may not be through-holes. The arrangement of the convex portions 90 and the concave portions 92 may be interchanged. That is, the insulating member 3 may include the concave portions 92, and the second cover 22 may include the convex portions 90. For example, in the embodiment, the structures corresponding to the first insulating walls 35a to 35d and the second insulating walls 36a to 36d may be arranged on the second cover 22, and the convex portions 90 may be arranged on the insulating walls in the second cover 22 corresponding to the first insulating walls 35a to 35d and the second insulating walls 36a to 36d, and the concave portions 92 may be arranged on the partition wall 31 of the insulating member 3.

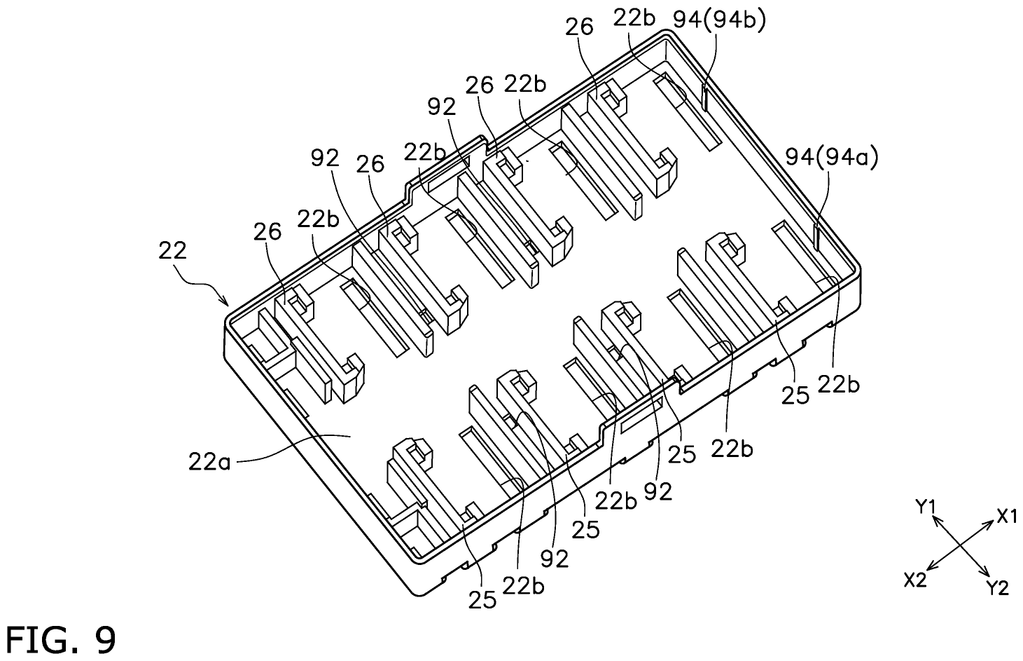

The first terminal fixing section 33 and the second terminal fixing section 34 of the insulating member 3 may be omitted. In that case, as shown in FIG. 9, the first fixed terminal 11 may be fixed by press-fitting to the first terminal fixing section 25 of the second cover 22, and the second fixed terminal 12 may be fixed by press-fitting to the second terminal fixing section 26 of the second cover 22.

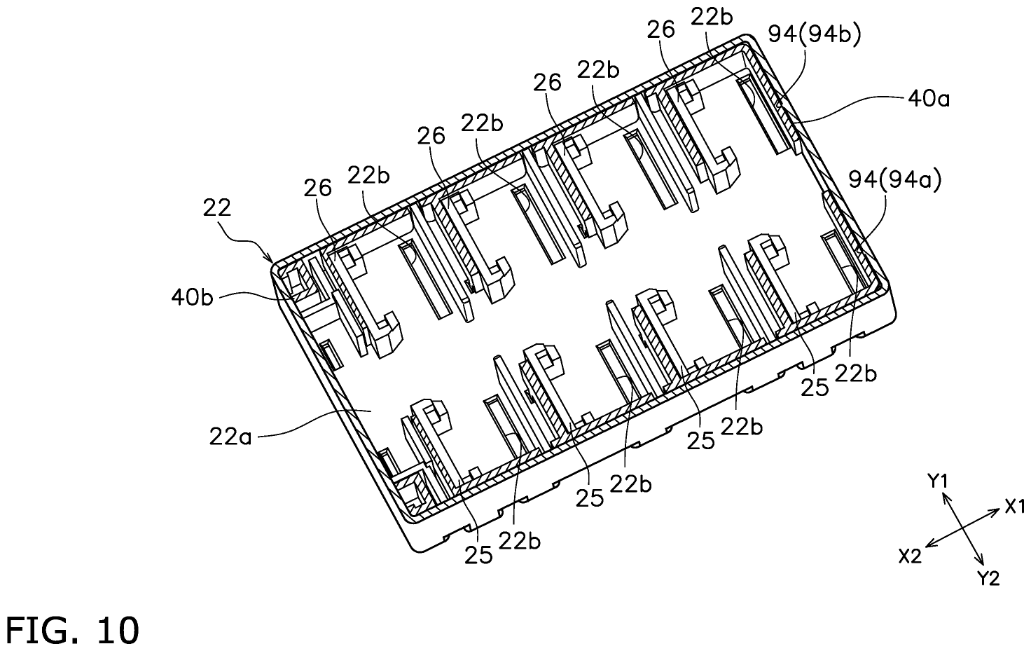

As shown in FIGS. 9 and 10, one of the insulating member 3 and the second cover 22 may include at least one pressing protrusion 94 that projects in the direction of movement of the movable contact piece 13. The other of the insulating member 3 and the second cover 22 is pressed against one of the insulating member 3 and the second cover 22 by at least one pressing protrusion 94, in the moving direction of the movable contact piece 13 (here, the front-rear direction), to be positioned. In the example shown in FIGS. 9 and 10, the second cover 22 includes a first pressing protrusion 94a and a second pressing protrusion 94b. The at least one pressing protrusion 94 has a rib shape. The first pressing protrusion 94a and the second pressing protrusion 94b protrude rearward from the inside of the front wall of the second cover 22. The first pressing protrusion 94a and the second pressing protrusion 94b press the first facing portion 40a of the insulating member 3, which faces the front wall of the second cover 22, rearward. With the configuration, the second facing portion 40b of the insulating member 3 facing the rear wall of the second cover 22 is pressed against the rear wall of the second cover 22, and the insulating member 3 is positioned in the front-rear direction. The first pressing protrusion 94a overlaps with the first fixed terminal 11 when viewed from the front and rear directions. The second pressing protrusion 94b overlaps the second fixed terminal 12 when viewed from the front-rear direction. Note that in FIGS. 9 and 10, the contact device 4 is not shown.

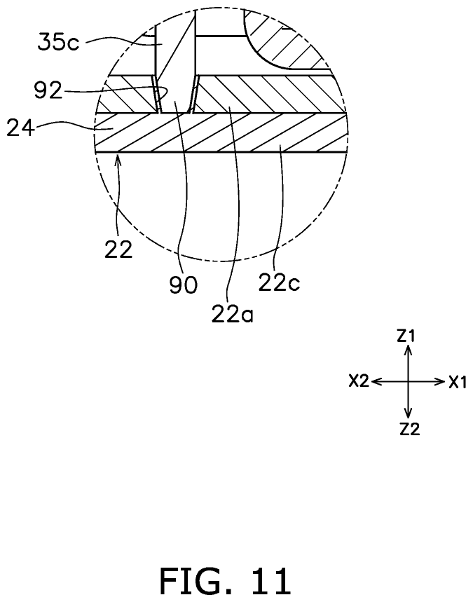

As shown in FIG. 11, when one of the insulating member 3 and the second cover 22 includes at least one pressing protrusion 94, preferably, the multiple convex portions 90 and the multiple concave portions 92 are fixed to each other via the adhesive 24. In the example shown in FIG. 11, the adhesive 24 is filled between the convex portions 90 and the concave portions 92.

### REFERENCE NUMERALS

1 Electromagnetic relay
22 Second cover (Example of Cover)
3 Insulating member
4 Contact device
5 Driving device
90 Multiple (i.e., a plurality of) convex portions
92 Multiple (i.e., a plurality of) concave portions

1. An electromagnetic relay, comprising:
a contact device including a first fixed terminal that has a first fixed contact, a second fixed terminal that has a second fixed contact, and a movable contact piece opposing the first fixed contact and the second fixed contact;
a driving device disposed on one side of a first direction with respect to the contact device, the driving device being configured to generate an electromagnetic force to move the movable contact piece;
an insulating member fixedly attached to the driving device, the insulating member separating the contact device from the driving device; and
a cover fixed to the insulating member, the insulating member defining an accommodation space together with the insulating member to accommodate the contact device,
wherein one of the insulating member and the cover includes a plurality of convex portions projecting toward the other of the insulating member and the cover, and
the other of the insulating member and the cover includes a plurality of concave portions to be fixed to the plurality of convex portions.

2. The electromagnetic relay according to claim 1, wherein
the plurality of convex portions projects along the first direction.

3. The electromagnetic relay according to claim 1, wherein
the plurality of convex portions is fixed to the plurality of concave portions by press-fitting.

4. The electromagnetic relay according to claim 1, wherein
the insulating member includes the plurality of convex portions,
the cover includes the plurality of concave portions,
the plurality of concave portions penetrates through the cover in the first direction, and
the plurality of convex portions and the plurality of concave portions are fixed to each other via adhesive.

5. The electromagnetic relay according to claim 4, wherein
the plurality of convex portions and the plurality of concave portions have a frustum shape.

6. The electromagnetic relay according to claim 1, wherein
one of the insulating member and the cover includes a pressing protrusion projecting in a direction of movement of the movable contact piece, and
the other of the insulating member and the cover is pressed against the one of the insulating member and the cover by the pressing protrusion to be positioned in the direction of movement of the movable contact piece.

7. The electromagnetic relay according to claim 1 wherein
the first fixed terminal and the second fixed terminal are fixed to the cover by press-fitting.

8. The electromagnetic relay according to claim 1 wherein
one of the insulating member and the cover includes an insulating wall extending in a direction intersecting a direction of movement of the movable contact piece, and
either the plurality of convex portions or the plurality of concave portions is disposed on the insulating wall.

9. The electromagnetic relay according to claim 8 wherein
one of the insulating member and the cover includes a first terminal fixing section to which the first fixed terminal is fixed, and
the first terminal fixing section is connected to the insulating wall.
